(19) United States
(12) Patent Application Publication
(10) Pub. No.: US 2006/0220801 A1
(43) Pub. Date: Oct. 5, 2006

(54) Safety device for non-guided vehicles

(75) Inventors: Wolf-Dietrich Bauer, Leinfelden-Echterdingen (DE); Christian Mayer, Reutlingen (DE); Andreas Schwarzhaupt, Landau (DE); Gernot Spiegelberg, Heimsheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/538,661

(22) PCT Filed: Oct. 23, 2003
(86) PCT No.: PCT/EP03/11743

§ 371 Date: Mar. 28, 2006

(30) Foreign Application Priority Data
Dec. 11, 2002 (DE) 102 57 798.6

(51) Int. Cl. B60Q 1/00

(52) U.S. Cl. 340/425.5; 340/901; 701/45

(57) ABSTRACT

A safety device for, in particular, nonrailborne vehicles, having a monitoring device to monitor a hazardous area and additionally the road area, located on the opposite side of the hazardous area viewed from the vehicle and adjoining the hazardous area. Obstacles in the hazardous area and/or road area are detected. An output signal is brought about if an obstacle which prevents the hazardous area being traveled through completely has been detected.

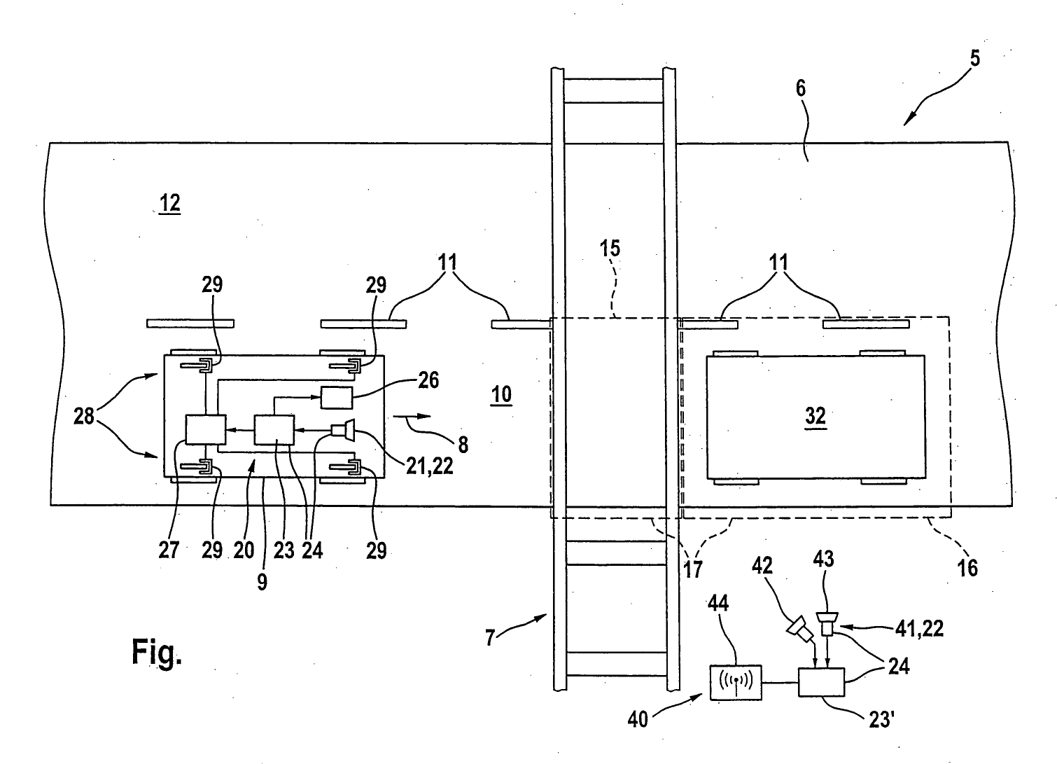

### BACKGROUND OF THE INVENTION

The invention relates to a safety device for, in particular, nonrailborne vehicles.

U.S. Pat. No. 6,084,508 describes an automatic emergency braking process is triggered if a collision with an obstacle located in the direction of travel or a vehicle intersecting the travel path can no longer be prevented. This is intended to alleviate the consequences of an accident. A disadvantage with this process is that it is not possible to prevent the accident but rather only to alleviate the consequences of an accident.

German reference DE 44 34 789 A1 discloses a hazardous area which is formed by a railway crossing and which is monitored by means of suitable sensors such as photoelectric barriers, for example. If a defect road vehicle happens to block the crossing, the approaching rail vehicle is made to execute an emergency stop. The blocked hazardous area is thus detected and the rail vehicle is braked in order to avoid an accident. It is disadvantageous here that the hazardous situation, specifically the blocked railway crossing, cannot be prevented. Measures are taken to avert serious consequences only when the hazardous situation has occurred.

### SUMMARY OF THE INVENTION

The foregoing background as a starting point, an object of the present invention is to provide a safety device that avoids the hazardous situation itself.

This object has been achieved according to the present invention by providing that the monitoring device additionally monitors the road area, located on the opposite side of the hazardous area viewed from the vehicle and adjoining the hazardous area, for obstacles and brings about an output signal if an obstacle which prevents the hazardous area being traveled through completely has been detected.

As a result, not only the hazardous area per se but also the road area adjoining the hazardous area are monitored to determine whether either the hazardous area or the road area is blocked by an obstacle. If this is the case, it is not possible for the hazardous area to be traveled through by the vehicle completely. In this case, an output signal is generated. The occurrence of a hazardous situation can be effectively avoided by blocking the hazardous area because the output signal is already generated if the vehicle cannot travel through the hazardous area completely. This provides a possible way of preventing the vehicle from entering the hazardous area. Traffic safety in a hazardous area such as a railway crossing, for example, is significantly increased in this way.

The monitoring device advantageously has an, in particular, optical sensor device such as, for example, a camera arrangement. The hazardous area and the road area are easily monitored by the sensor device or the camera arrangement. When a sensor device which forms images is used, the recorded image can be displayed to the driver of the vehicle in order to provide the driver with additional traffic information.

The safety device may be embodied as a mobile safety device and arranged in the vehicle. This has the advantage that the vehicle does not need to rely on any other devices and is therefore independent.

Alternatively, it is also contemplated to arrange at least parts of the monitoring device in a fixed fashion in the vicinity of the hazardous area. In this context, for example, the sensor device can be fixed in the vicinity of the hazardous area. This embodiment reduces the expenditure on retrofitting the vehicle. The sensor device does not need to be provided in each vehicle but rather can be mounted as a separate device in the vicinity of the hazardous area. This also reduces costs and the weight of the vehicle.

The monitoring device can have an evaluation device which receives and evaluates the sensor signals of the sensor device in order to detect an obstacle in the monitored space. If the sensor device is embodied as a sensor device which outputs images, for example a camera arrangement, the evaluation device can use known image processing methods to evaluate the recorded image to determine whether an obstacle is present in the monitored space formed by the hazardous area and the road area and is blocking the possibility of traveling through the hazardous area. It is therefore possible to resort to such known image processing methods.

A driver warning which can be displayed to the driver by optical and/or acoustic and/or haptic display apparatus is advantageously triggered by the output signal of the monitoring device. Because the driver is provided with information, she can react appropriately and brake the vehicle before it enters the hazardous area, for example.

Alternatively or additionally to the foregoing, it is expedient if the output signal triggers an automatic braking process of the vehicle such that the vehicle comes to a standstill before entering the hazardous area. In this embodiment the entry into the hazardous area can be prevented by the safety device itself independently of the attentiveness or the reaction of the driver. This provides an additional safety benefit.

### BRIEF DESCRIPTION OF THE DRAWINGS

The single FIGURE is a schematic diagram in the vicinity of a hazardous area, with a first and second embodiments of the safety device.

### DETAILED DESCRIPTION OF THE DRAWINGS

An intersection area 5 between a road 6 and a rail vehicle 7 is shown in the diagram. The road 6 has, as viewed in the travel direction 8 of the vehicle 9, a first lane 10 which is separated by a line marking 11 from a second lane 12 which is provided for the opposite travel direction to the travel direction 8 of the vehicle 9.

The area in which the rail 7 and the first lane 10 of the road 6 intersect constitutes a hazardous area 15 because in this area collisions can occur between the vehicle 9 in the lane 10 and a rail vehicle traveling on the rail 7.

The hazardous area 15 is adjoined, viewed in the travel direction 8 of the vehicle 9, by a road area 16 whose width viewed in the transverse direction with respect to the travel direction 8 of the vehicle 9 corresponds approximately to the width of the first lane 10, and whose length viewed in the travel direction 8 of the vehicle 9 corresponds at least to one vehicle length. Relatively long vehicles such as semitrailers or lorries with trailers are also contemplated as the vehicle 9, and the length of the road area 16 should therefore be selected accordingly. The hazardous area 15 and the road area 16 form a monitored area 17 which is monitored by a safety device which is described below.

The vehicle 9 which travels in the travel direction 8 and is located in the first lane 10 has a first safety device designated generally by numeral 20. The first safety device 20 contains a sensor device 22 comprised of a camera 21 to generate a sensor signal corresponding to the recorded image which is transmitted to an evaluation device 23. The sensor device 22 and the evaluation device 23 are components of a monitoring device 24 of the first safety device 20. The illustrated evaluation device 23 is connected, for example, to display 26 and to a brake control device 27 of the brake device 28 of the vehicle 9. The brake control device 27 is used to actuate the wheel brake devices 29.

If the vehicle 9 approaches the hazardous area 15 in the first lane 10, images of the monitored space 17 formed by the hazardous area 15 and by the road area 16 are recorded continuously or cyclically by the camera 21 and transmitted to the evaluation device 23 in the form of the sensor signal. The detection of a hazardous area 15 is carried out in the evaluation device 23 by known image processing methods. For example, features which characterize a hazardous area 15 can be detected in the recorded image, thus permitting the approach of the vehicle 9 to a hazardous area 15 to be inferred. Such features are, for example, traffic signs and warning signs at the edge of the road. In the case of the railway crossing illustrated by way of example it is also possible to use railway barriers, the rail 7 or the like as characteristic features.

Furthermore, the evaluation device 23 evaluates the sensor signal to determine whether there is an obstacle 32 in the monitored space 17. If an obstacle 32 is detected neither in the hazardous area 15 nor in the road area 16, it is inferred therefrom that the hazardous area 15 can be traveled through completely by the vehicle 9 so that the evaluation device 23 does not generate an output signal.

In the illustrated situation, an obstacle 32 which is formed by another vehicle is located in the road area 16. Owing to the chronological sequence of the images recorded by the camera 21, the evaluation device 23 can infer whether the obstacle 32 is a moving obstacle or a stationary obstacle. If it is detected that the obstacle 32 does not move during a predefined time period, or only moves insignificantly, it is not possible for the vehicle 9 to travel completely through the hazardous area 15 and the evaluation device 23 causes an output signal to be generated.

For example, the output signal which is triggered by the evaluation device 23 brings about a multi-stage reaction of the first safety device 20. The display 26 provided in the vehicle 9 makes the driver aware of the traffic situation, and this can be done visually and/or audibly and/or haptically. If the driver does not react within a predefined reaction time, the evaluation device 23 triggers an automatic braking process which is independent of the driver by way of the braking control device 27. The deceleration of the vehicle or the brake pressure or the braking force in the wheel brake devices 29 is selected here such that the vehicle 9 comes to a standstill before it enters the hazardous area 15.

The control operating activity of the driver can be used to detect whether the driver reacts during the issuing of the warning by the display 26. For example, a reaction by the driver is inferred if one or more of the pedals of the vehicle or the steering handle are activated. In this case, an automatic braking process which is independent of the driver does not take place.

The wheel brake devices 29 of the vehicle are enabled again after an automatic braking process has been carried out if the vehicle 9 has completely come to a standstill or if the possibility of traveling through the hazardous area 15 completely is detected by of the first safety device 20.

The sole FIGURE also illustrates a further embodiment of the safety device according to the invention which is referred to as a second safety device 40. In contrast to the first safety device 20, the sensor device 22 is comprised of a camera arrangement 41 which has a first camera 42 and a second camera 43. For example, the first camera 42 is provided for monitoring the hazardous area 15, and the second camera 43 is provided for monitoring the road area 16. The camera arrangement 41 is connected to an evaluation device 23′ which is in turn connected to a transmitter 44. The second safety device 40 is embodied in a fixed fashion as a central safety device. The method of operation corresponds to that of the first safety device 20 described above. In contrast to the first safety device 20, the output signal of the evaluation device 23′ of the second safety device 40 is transmitted via the transmitter 44 to the vehicle 9 which, in this embodiment, has a receiver (not illustrated in more detail) connected to the display 26 and the brake control device 27. Because the sensor device 22 and the evaluation device 23′ are embodied in a centralized, fixed fashion in the second safety device 40, these devices can be dispensed with in the vehicle 9.

In a further modification of the above described embodiments, the evaluation device 23, 23′ can also generate a signal if an obstacle 32 has been detected neither in the hazardous area 15 nor in the road area 16. This signal, which could be referred to, for example, as a proceed signal, can be of complementary design to the output signal so that the output signal corresponds, for example, to a logic one, and the proceed signal corresponds to a logic zero. In the first safety device 20 it is also contemplated to provide a camera arrangement having a plurality of cameras, instead of one camera 21.

Furthermore it is also contemplated for other sensors, for example radar sensors, to be used instead of a camera. The sensor arrangement 22 can also have sensors which are based on various physical measurement principles in order to compensate physical disadvantages of certain sensor types.

1-9. (canceled)

10. A safety device for in particular nonrailborne vehicles, comprising a monitoring device configured to monitor a hazardous area and a road area, located on the opposite side of the hazardous area as viewed from the vehicle and adjoining the hazardous area, to detect obstacles in at least one of the hazardous area and the road area, wherein the length of the road area corresponds at least to one vehicle length viewed in a travel direction of the vehicle, and the monitoring device is arranged to trigger an output signal to prevent entry into the hazardous area if an obstacle which prevents the hazardous area being traveled through completely has been detected.

11. The safety device as claimed in claim 10, wherein the monitoring device comprises an optical sensor.

12. The safety device as claimed in claim 11, wherein the sensor device comprises a camera.

13. The safety device as claimed claim 10, wherein the monitoring device is arranged in the vehicle.

14. The safety device as claimed in claim 10, wherein at least portions of the monitoring device are fixed in the vicinity of the hazardous area.

15. The safety device as claimed in claim 14, wherein the monitoring device comprises an optical sensor.

16. The safety device as claimed in claim 15, wherein the sensor device comprises a camera.

17. The safety device as claimed in claim 10, wherein the monitoring device comprises an evaluation device configured to receive and evaluate sensor signals of the sensor device to detect an obstacle in the monitored space.

18. The safety device as claimed in claim 10, wherein the output signal generated by the monitoring device is operable to trigger a driver warning using a display.

19. The safety device as claimed in claim 10, wherein the output signal generated by the monitoring device is operable to trigger an automatic braking process of the vehicle such that the vehicle comes to a standstill before entering the hazardous area.

20. The safety device as claimed in claim 18, wherein the output signal generated by the monitoring device is operable to trigger an automatic braking process of the vehicle such that the vehicle comes to a standstill before entering the hazardous area.
